(19) United States
(12) Patent Application Publication
(10) Pub. No.: US 2024/0292334 A1
(43) Pub. Date: Aug. 29, 2024

(54) METHOD FOR AT LEAST ONE MOBILE DEVICE TO COMMUNICATE WITH A MOBILE NETWORK BASE STATION

(71) Applicant: MERCEDES-BENZ GROUP AG, Stuttgart (DE)

(72) Inventor: Osman AYDIN, Leinfelden-Echterdingen (DE)

(21) Appl. No.: 18/570,163

(22) PCT Filed: May 25, 2022
(86) PCT No.: PCT/EP2022/064324

§ 371 Date: Dec. 14, 2023

(30) Foreign Application Priority Data
Jun. 15, 2021 (DE) 10 2021 003 075.3

(51) Int. Cl. H04W 52/02; H04W 88/06

(52) U.S. Cl. CPC H04W 52/0251; H04W 88/06

(57) ABSTRACT

A method for a mobile device to communicate with a mobile network base station in which at least one subset of information exchanged between the mobile device and the mobile network base station is communicated while using coverage enhancement. The mobile device activates a coverage enhancement mode depending on an available quantity of electrical energy for operating the mobile device, depending on a critical temperature of the mobile device or of a component of the mobile device, and/or depending on an ambient temperature around the mobile device, in which mode the mobile device exchanges information with the mobile network base station while using coverage enhancement.

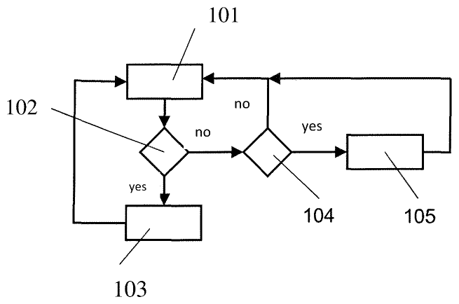

### BACKGROUND AND SUMMARY OF THE INVENTION

Exemplary embodiments of the invention relate to a method for at least one mobile device to communicate with a mobile network base station and to a vehicle having at least one mobile device.

The 3rd Generation Partnership Project (3GPP) is a worldwide cooperation of standardization bodies for standardization in mobile communications. 3GPP creates technical specifications describing every aspect of mobile communications technology so precisely that mobile devices made by very different manufacturers function without error in all mobile networks worldwide. The mobile communications standards hereby defined are, for example, GSM, UMTS or LTE. The mobile communications standards are also referred to as 2G, 3G and 4G. As development progresses, it is also possible to transmit comparatively large quantities of data, for example via the currently introduced mobile communications standard, 5G. As research progresses and future technologies are introduced, such as 6G, 7G or subsequent mobile communications standards, a further increase in the data rate transmitted via mobile communications should also be expected.

Transmitting data requires the presence of a sufficient radio signal strength. If a distance of a mobile device from a transmission station increases, this mobile communications signal becomes increasingly weaker until the mobile communications signal is too weak to transmit large data streams. If there are obstructions, e.g., high rises, bridges, hills or trees and sources of interference, e.g., sources of electromagnetic radiation such as transformers in the region between the mobile device and the base station, the mobile communications signal can be additionally disturbed.

To ensure successful communication between the mobile device and the base station, at a comparatively weak mobile signal, 3GPP has introduced so-called coverage enhancement. By means of coverage enhancement, it is possible to securely and reliably exchange comparatively low data rates at a comparatively weak mobile communications signal over comparatively large geographic ranges. The data transmission is implemented at a comparatively low transmission power, whereby little power is used. To carry out coverage enhancement, a corresponding base station and a respective mobile device must have specific transmission and reception hardware. Coverage enhancement can for example be realized via LTE-M, LTE-MTC or LTE-Cut-M, or also via newer standards such as LPWAN or NB-IoT.

The increased range using coverage enhancement is based on transmitting the same data several times. The weaker a mobile communications signal between a mobile device and a base station, the more repetitions are necessary to guarantee a successful data transmission between the two communications participants. The repeated transmission of the same data requires available bandwidth, which is one reason why only comparatively low data rates can be transmitted. Coverage enhancement is thus only suitable for applications in which comparatively little data or a low data rate need to be reliably transmitted even in a poor reception situation.

Such applications can be found in the automotive sector. With increasing digitalization, vehicles are also increasingly networked, the vehicles then being in the position to exchange data with other vehicles via a vehicle-to-vehicle interface, to exchange data with infrastructure, e.g., a toll station, via a vehicle-to-infrastructure interface or to transmit information via mobile communications via a vehicle-to-network interface. If such a vehicle, which is capable of communication, drives into a dead zone on its route, sometimes no information can be transmitted via a conventional mobile communications standard such as LTE or 5G as the reception quality is too poor. Using coverage enhancement, however, successful communication between the mobile device and the mobile network base station can be ensured for greater distances.

Due to the reduced data rate, however, only selected information can be transmitted. For communication using coverage enhancement, for example, the following information is relevant: vehicle status updates, an unlocking or locking command to open or lock vehicle doors, and/or vehicle diagnostic data.

A method for monitoring a radio signal quality using coverage enhancement is known from WO 2018/213166 A1. Using the method described in the document, a coverage enhancement level is changed such that a data rate required to carry out coverage enhancement is optimally adjusted to a currently available receiving signal strength. If a mobile device moves away from a mobile network base station, a high coverage enhancement level is selected, which is associated with a high repetition rate of a mobile communications signal to be transmitted. If, however, the mobile device nears the mobile network base station, a comparatively low coverage enhancement level is selected, which is connected with a lower data repetition rate. Network communication resources can thus be saved, and thus optimally used.

Exemplary embodiments of the present invention are directed to an improved method for at least one mobile device to communicate with a mobile network base station, using which a communication between the mobile device and the mobile network base station can still be maintained in the event that there is a threat of thermal damage to the mobile device in a usual operating mode and/or an energy reserve that is required to operate the mobile device runs low.

In a method for at least one mobile device to communicate with a mobile network base station of the kind described in the introduction, the mobile device activates a coverage enhancement mode depending on an available quantity of electrical energy for operating the mobile device and/or depending on a critical temperature of the mobile device, a component of the mobile device and/or an ambient temperature around the mobile device, in which mode the mobile device exchanges information with the mobile network base station while using coverage enhancement. Less energy is required to operate the mobile device in the coverage enhancement mode than to communicate via a conventional mobile communications standard such as 2G to 5G or a future mobile communications standard such as 6G.

If an available quantity of electrical energy to operate the mobile device falls below a pre-determined critical value, the mobile device switches into the coverage enhancement mode, and ends a communication with the mobile network base station via a conventional mobile communications standard. An energy consumption of the mobile device is thus reduced. Because the mobile device thus requires less power, it also empties an energy storage device that stores the quantity of electrical energy more slowly, and can thus be used for a longer period of time. The energy storage device can be comprised by the mobile device and/or be connected to the mobile device in the form of an external energy storage device.

If the energy consumption of the mobile device is reduced by activating the communication based on coverage enhancement, the thermal output emitted by electronic components by dissipation of current is also reduced. The risk of thermal damage to the mobile device is thus reduced.

To determine a threat of the mobile device or components of the mobile device overheating in time, corresponding components and/or an ambient temperature around the mobile device is monitored. Several temperatures can also be monitored simultaneously. The waste heat that leads to the critical temperature being reached can be emitted both by the mobile device and its individual components and by further devices arranged in proximity of the mobile device, e.g., a computer, a battery module, a thermal power unit, or the like. If merely activating the coverage enhancement mode is not sufficient to prevent the mobile device from overheating, the operation of the further device can also be reduced, limited, or ended. The amount of heat emitted to the mobile device can thus be further reduced.

It is generally also conceivable that the coverage enhancement mode is activated if the critical temperature is fallen short of.

An advantageous development of the method provides that the electrical energy used to operate the mobile device is drawn from a vehicle battery. The mobile device can be integrated into a vehicle having the vehicle battery or be transported with the latter. The vehicle can be a hybrid vehicle, a plug-in hybrid vehicle or a vehicle driven purely by an electric battery. The vehicle battery can additionally be a traction battery.

If, for example, the mobile device is a smartphone, the smartphone can be charged via the vehicle battery. If the battery of the smartphone is empty, the smartphone can thus be operated for longer. Electrical energy can be transferred to the smartphone via a cable connection or in a contactless manner, for example using induction.

Preferably, the coverage enhancement mode is activated if the vehicle battery falls below a critical state of charge. The communication between the mobile device and the mobile network base station can thus be maintained for a longer period of time due to the reduced power consumption of the mobile device. The critical state of charge can be any value, for example 50%, 30%, 10% or the like. It can thus be ensured that the vehicle battery of a vehicle driven purely by an electric battery contains a sufficient energy reserve, such that the vehicle can reach a charging station to recharge the vehicle battery.

A further advantageous embodiment of the method further provides that the coverage enhancement mode is activated if the critical temperature is exceeded. Damage to the mobile device or individual components of the mobile device due to overheating can thus be avoided.

The critical temperature is preferably 100° C. The mobile device can have mechanisms for heat removal, such as passive and/or active cooling bodies. If it can no longer be prevented with these mechanisms that the critical temperature is exceeded, the mobile device or individual components of the mobile device can overheat due to operation of the mobile device in the coverage enhancement mode. Damage to the mobile device or individual components, e.g., capacitors, can arise at a temperature as low as 100° C. The mobile device or components of the mobile device emit less heat due to operation in the coverage enhancement mode. This means that active cooling is no longer required, whereby more energy can be saved.

If the coverage enhancement mode is activated when the critical temperature is fallen short of, the critical temperature can be a comparatively cold temperature, e.g., −50° C.

A further advantageous embodiment of the method according to the invention further provides that before the vehicle battery is emptied, a mobile electric charging station or a towing service is called to a current or future location of a vehicle comprising the vehicle battery. On the one hand, the comfort of a person driving the vehicle can thus be improved, because the person driving the vehicle thus need not intervene manually to ensure energy supply of the vehicle. This happens fully automatically. The mobile device can thus independently inform a corresponding mobile electric charging station or a towing service. For this purpose, the mobile device can access vehicle status data and/or further information where required. The mobile device can thus also read the current and/or future location of the vehicle, for example from a navigation device of the vehicle, and transmit it via mobile communications. The information about the future location of the vehicle can also be supplemented with a state of charge of the vehicle battery. It can thus be determined at which location the critical state of charge of the vehicle battery is likely to be fallen short of.

The mobile electric charging station or the towing service is then preferably called to the future location of the vehicle, such that the vehicle and the mobile electric charging station or the towing service simultaneously arrive at the future location, or the electric charging station or the towing service is already present when the vehicle arrives. This enables the vehicle battery to be charged particularly quickly or other maintenance of a faulty vehicle function by the towing service or else the towing of the vehicle.

Generally, the mobile electric charging station or the towing service can also be called before switching into the coverage enhancement mode.

To determine the current vehicle position, the vehicle can, for example, have a navigation device or communicate with a navigation device of a mobile terminal such as a smartphone, and determine the vehicle position, for example using a global satellite navigation system such as GPS. A future location of the vehicle can be determined by a route programmed into the navigation device. Behavior patterns can also be analyzed, whereby routes that are followed by the vehicle particularly frequently can be determined. It can thus be estimated when and where the vehicle will probably be located, in particular when the critical state of charge of the vehicle battery is reached.

Corresponding to a further advantageous embodiment of the method, a terrestrial unit, a satellite unit, and/or a drone unit is used as a mobile network base station. The terrestrial unit can, for example, be a radio station. The drone unit can, for example, be at least one drone, such as a quadrocopter or another UAV. The drone can also be designed as a balloon. Using satellites and drones, mobile network coverage can be ensured in areas that are difficult to access or not covered by infrastructure. Generally, the areas supplied with mobile communications by a mobile network base station can also partially overlap. The mobile network base station can establish communication with a mobile device based on electromagnetic waves. Any mobile communications technology, such as 2G to 5G, or future mobile communications standards such as 6G or the like can be used. Any radio technology, e.g., wi-fi, Bluetooth, radio or the like can also be used for communication between the mobile device and the mobile network base station. If the mobile device activates the coverage enhancement mode, it ends communication with the mobile network base station based on the usual radio technologies listed. The communication between the mobile device and the mobile network base station takes place in the coverage enhancement mode, and thus exclusively using coverage enhancement.

If the vehicle battery is charged again, or if the critical state of charge of the vehicle battery is changed to a lower value, for example because a destination of the vehicle has been changed, the coverage enhancement mode can also be deactivated again, and the mobile device can communicate with a mobile network base station via a usual communication channel. Of course, this can also take place if the critical temperature is fallen short of. The coverage enhancement mode can thus be ended if the mobile device, a component of the mobile device and/or the ambient temperature around the mobile device is cooled sufficiently.

In the case of a vehicle having at least one mobile device, the mobile device is equipped according to the invention to carry out a method previously described. The vehicle can be any vehicle, such as a passenger car, HGV, truck, bus, or the like. The mobile device or several mobile devices can be fixedly integrated in the vehicle or be transported with the vehicle, e.g., in the form of a mobile terminal. The mobile terminal can, for example, be a smartphone. Using such a vehicle and such a method, a transfer of critical vehicle data, e.g., of vehicle status data to a vehicle manufacturer for vehicle monitoring, can also be ensured in critical situations. Existing mobile communication can thus also be maintained when a vehicle battery is emptying and/or damage to the mobile device is imminent due to overheating.

Preferably, the mobile device is designed as a vehicle telecommunications unit. A vehicle telecommunications unit is typically formed by a vehicle manufacturer during production of the vehicle. The vehicle manufacturer thus has the possibility of integrating the mobile device particularly deeply into the vehicle. This makes it easier to read information relevant to the vehicle, such as sensor data, and to transmit the sensor data via mobile communications and/or to receive status updates or software updates “over the air”. The method according to the invention can thus be used particularly easily in a vehicle.

The mobile device is preferably equipped:
to activate or to end the coverage enhancement mode during a journey, while at a standstill, when the vehicle doors are locked and/or from a standby mode; and/or
to wake up a vehicle subsystem in a standby mode.

This enables a method according to the invention to be carried out in very different driving situations. In particular, an energy-efficient wake-up of a vehicle subsystem is guaranteed. This is particularly advantageous when a vehicle battery is almost empty.

Further advantageous embodiments of the method according to the invention result from the exemplary embodiment, which is described in more detail in the following with reference to the single FIGURE.

### BRIEF DESCRIPTION OF THE SOLE FIGURE

The sole FIGURE shows a process diagram of a method according to the invention.

### DETAILED DESCRIPTION

In a first method step 101, a state of charge of a vehicle battery and a temperature of a mobile device, a component of the mobile device, and/or an ambient temperature around the mobile device is monitored. The environment around the mobile device can be monitored up to a fixed distance. In particular, temperature sensors are placed at critical points, e.g., in a flow path from which the mobile device receives air for cooling and/or in the region of temperature-sensitive components such as capacitors.

In a following method step 102, it is checked whether a state of charge of the vehicle battery falls short of a critical value and/or the temperature of the mobile device or an ambient temperature around the mobile device exceeds or falls short of a critical value. If this is the case, a coverage enhancement mode is activated in a method step 103, in which coverage enhancement mode the mobile device communicates with a mobile network base station exclusively via coverage enhancement. The mobile device thus uses less power, and heats up less significantly or cools due to the lower power usage.

On the other hand, if the state of charge of the vehicle battery is sufficient or the critical temperature has not yet been reached, it is checked in the method step 104 whether the coverage enhancement mode is active. If this is not the case, the battery state of charge and the temperatures continue to be monitored. If, however, the coverage enhancement mode is active, the latter can now be ended while guaranteeing component protection and a secure mode of operation of the mobile device and of the vehicle. This takes place in the method step 105.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the FIGURES enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method, comprising:
communicating, by a mobile device, with a mobile network base station;
determining whether to activate coverage enhancement mode depending on an available quantity of electrical energy for operating the mobile device, a critical temperature of the mobile device, a critical temperature of a component of the mobile device, or an ambient temperature around the mobile device; and
switching to and communicating using the coverage enhancement mode responsive to determining to activate the coverage enhancement mode, wherein at least one subset of information is exchanged between the mobile device and the mobile network base station using coverage enhancement of the coverage enhancement.

12. The method of claim 11, wherein the electrical energy used to operate the mobile device is drawn from a vehicle battery.

13. The method of claim 12, wherein the coverage enhancement mode is activated when the vehicle battery falls short of a critical state of charge.

14. The method of claim 11, wherein the coverage enhancement mode is activated if the critical temperature of the mobile device or of the component of the mobile device is exceeded.

15. The method of claim 14, wherein the critical temperature of the mobile device or of the component of the mobile device is 100° C.

16. The method of claim 12, wherein, prior to the vehicle battery being emptied, a mobile electric charging station or a towing service is called to a current or future location of a vehicle comprising the vehicle battery.

17. The method of claim 11, wherein the mobile network base station is a terrestrial unit, a satellite unit, or a drone unit.

18. A vehicle, comprising:
a mobile device, configured to
communicate with a mobile network base station;
determine whether to activate coverage enhancement mode depending on an available quantity of electrical energy for operating the mobile device, a critical temperature of the mobile device, a critical temperature of a component of the mobile device, or an ambient temperature around the mobile device; and
switch to and communicate using the coverage enhancement mode responsive to determining to activate the coverage enhancement mode, wherein at least one subset of information is exchanged between the mobile device and the mobile network base station using coverage enhancement of the coverage enhancement.

19. The vehicle of claim 18, wherein the mobile device is a vehicle telecommunications unit.

20. The vehicle of claim 18, wherein the mobile device is configured to:
activate or end the coverage enhancement mode during a journey, while at a standstill, when vehicle doors are locked, or from a standby mode; or
wake up a vehicle subsystem in a standby mode.
